(19) United States
(12) Patent Application Publication
(10) Pub. No.: US 2020/0388874 A1
(43) Pub. Date: Dec. 10, 2020

(54) PLANAR, THIN-FILM ELECTROCHEMICAL DEVICE AND METHOD OF MAKING THE SAME

(71) Applicant: GM GLOBAL TECHNOLOGY OPERATIONS LLC, Detroit, MI (US)

(72) Inventors: Evan J. DAWLEY, Bloomfield Hills, MI (US); Mahmoud ABD ELHAMID, Troy, MI (US)

(73) Assignee: GM GLOBAL TECHNOLOGY OPERATIONS LLC, Detroit, MI (US)

(21) Appl. No.: 16/434,671

(22) Filed: Jun. 7, 2019

(51) Int. Cl. H01M 10/02; H01M 2/10; H01M 10/0525

(52) U.S. Cl. CPC H01M 10/02; H01M 2220/20; H01M 10/0525; H01M 2/1077

(57) ABSTRACT

A thin, conformable electrochemical device according to various aspects of the present disclosure includes an electrically-insulating housing, a plurality of current collectors, a plurality of electrochemical cells, and positive and terminals. The housing includes first and second film portions that cooperate to at least partially define an interior region. The current collector and electrochemical cells are disposed within the interior region. The electrochemical cells are electrically connected to one another via the current collectors. The plurality of electrochemical cells includes a first electrochemical cell and a second electrochemical cell. Each electrochemical cell includes a positive electrode, a negative electrode, and a separator. The positive and negative terminals are electrically connected to the electrochemical cells. In certain aspects, electrochemical devices according to the present disclosure are conformable such that they can be bent, folded, or twisted to fit within a desired space without significantly impacting performance or otherwise suffering damage.

### INTRODUCTION

This section provides background information related to the present disclosure which is not necessarily prior art.

The present disclosure pertains to high-energy density, electrochemical cells, such as lithium-ion batteries. Such high-energy density batteries can be used in a variety of consumer products and vehicles, such as hybrid or electric vehicles. Battery powered vehicles show promise as a transportation option as technical advances continue to be made in battery power, lifetimes, and manufacturing.

### SUMMARY

This section provides a general summary of the disclosure, and is not a comprehensive disclosure of its full scope or all of its features.

In various aspects, the present disclosure provides a thin, conformable electrochemical device. The electrochemical device includes an electrically-insulating housing, a plurality of current collectors, a plurality of electrochemical cells, a positive terminal, and a negative terminal. The electrically-insulating housing includes a first film portion and a second film portion. The first and second film portions cooperate to at least partially define an interior region. The plurality of current collectors is disposed within the interior region. The plurality of current collectors includes a first current collector coupled to the first film portion, a second current collector coupled to the first film portion, a third current collector coupled to the second film portion, and a fourth current collector coupled to the second film portion. The plurality of electrochemical cells is disposed within the interior region. The electrochemical cells are electrically connected to one another. The plurality of electrochemical cells includes a first electrochemical cell and a second electrochemical cell. The first electrochemical cell includes a first positive electrode, a first negative electrode, and a first separator. The first positive electrode is electrically connected to one of the first current collector or the third current collector. The first negative electrode is electrically connected to the other of the first current collector or the third current collector. The first separator is disposed between the first positive electrode and the first negative electrode. The second electrochemical cell includes a second positive electrode, a second negative electrode, and a second separator. The second positive electrode is electrically connected to one of the second current collector or the fourth current collector. The second negative electrode is electrically connected to the other of the second current collector or the fourth current collector. The second separator is disposed between the second positive electrode and the second negative electrode. The positive terminal is electrically connected to the plurality of electrochemical cells. The positive terminal extends from the interior region to an exterior region of the electrically-insulating housing. The negative terminal is electrically connected to the plurality of electrochemical cells. The negative terminal extends from the interior region to the exterior region of the electrically-insulating housing.

In one aspect, the first electrochemical cell and the second electrochemical cell are electrically connected in series.

In one aspect, the plurality of electrochemical cells includes at least one series electrical connection and at least one parallel electrical connection.

In one aspect, the first current collector is in direct contact with the second current collector.

In one aspect, a first layer including a first electrically-conductive material is disposed on the first film portion in a first region and a second region. A second layer including a second electrically-conductive material is disposed on the first layer in the first region. The first current collector includes the first layer and the second layer in the first region. The second current collector includes the first layer in the second region.

In one aspect, the thin, conformable electrochemical device is configured to be bent about a first axis and a second axis substantially perpendicular to the first axis.

In one aspect, the thin, conformable electrochemical device has a thickness of less than or equal to about 0.5 mm.

In one aspect, the plurality of electrochemical cells includes greater than or equal to ten electrochemical cells.

In various aspects, the present disclosure provides a method of manufacturing a thin, conformable electrochemical device. The method includes forming a first precursor. Forming the first precursor includes coupling a plurality of current collectors to an electrically-insulating housing. A first portion of the plurality of current collectors is coupled to a first film portion of the housing. A second portion of the plurality of current collectors is coupled to a second film portion of the housing. The method further includes forming a second precursor. Forming the second precursor includes disposing a plurality of electrodes on the plurality of current collectors. A third portion of the plurality of electrodes is disposed on the first portion of the plurality of current collectors, respectively. A fourth portion of the plurality of electrodes is disposed on the second portion of the plurality of current collectors, respectively. The method further includes forming a third precursor. Forming the third precursor includes disposing a plurality of separators on a fifth portion of the plurality of electrodes. The method further includes forming a fourth precursor. Forming the fourth precursor includes assembling a plurality of electrochemical cells. Each electrochemical cell includes a separator of the plurality of separators. The separator is disposed between an electrode of the third portion of the plurality of electrodes and an electrode of the fourth portion of the plurality of electrodes. The method further includes electrically connecting the plurality of electrochemical cells to one another. The method further includes forming the electrochemical device. Forming the electrochemical devices includes coupling the first film portion to the second film portion. The first film portion and the second film portion cooperate to at least partially define an interior region in which the plurality of electrochemical cells are disposed. The positive terminal and the negative terminal each extend from the interior region to an exterior region.

In one aspect, the forming the first precursor includes at least one of printing or plasma-depositing the plurality of current collectors on the electrically-insulating housing.

In one aspect, the forming the first precursor is performed concurrently with the electrically connecting. The electrically connecting includes directly contacting a first current collector of the first portion of the plurality of current collectors with a second current collector of the first portion of the plurality of current collectors.

In one aspect, the forming the first precursor includes at least one of printing or plasma-depositing a first layer on a first region of the first film portion and a second region of the first film portion, and a second layer on the first layer in the first region. The first layer includes a first electrically-conductive material. The second layer includes a second electrically-conductive material. A first current collector includes the first layer and the second layer and is disposed in the first region. A second current collector includes the first layer and is disposed in the second region.

In one aspect, the forming the second precursor includes at least one of printing or plasma-depositing the plurality of electrodes on the plurality of current collectors, respectively.

In one aspect, the electrically connecting includes forming a joint between a pair of electrochemical cells of the plurality of electrochemical cells. The forming includes at least one of printing, plasma-depositing, welding, laser joining, resistance joining, or soldering.

In one aspect, the forming the third precursor includes at least one of printing or plasma-depositing a solid-state electrolyte on the fifth portion of the electrodes.

In one aspect, the fifth portion of the electrodes includes every electrode of the plurality of electrodes.

In one aspect, the electrically-insulating housing includes a sheet including the first film portion and the second film portion. The forming the fourth precursor includes folding the sheet along a boundary between the first film portion and the second film portion such that the plurality of separators is disposed between the third portion of the plurality of electrodes and the fourth portion of the plurality of electrodes.

In one aspect, the forming the fourth precursor includes stacking one of the first film portion or the second film portion on the other of the first film portion or the second film portion such that the plurality of separators is disposed between the third portion of the plurality of electrodes and the fourth portion of the plurality of electrodes.

In one aspect, the method further includes adjusting a voltage of the electrochemical device by adjusting a quantity of electrochemical cells of the plurality of electrochemical cells. The electrochemical cells are electrically connected in series.

In one aspect, the method further includes adjusting a current of the electrochemical device by adjusting at least one of (i) a first cross sectional area of the positive terminal, (ii) a second cross sectional area of the negative terminal, or (iii) third cross sectional areas of the plurality of current collectors.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of an electrochemical cell according to various aspects of the present disclosure;

FIG. 2 is a perspective view of a thin, conformable electrochemical device according to various aspects of the present disclosure;

FIGS. 3A-3C depict the electrochemical device of FIG. 2; FIG. 3A is a schematic view of the electrochemical device electrically connected to a circuit; FIG. 3B is a sectional view taken at line 3B-3B of FIG. 3A; and FIG. 3C is a sectional view taken at line 3C-3C of FIG. 3A;

FIG. 4 is a flowchart depicting a method of manufacturing a conformable, thin-film electrochemical device according to various aspects of the present disclosure;

FIGS. 5A-5B depict a first electrochemical device precursor; FIG. 5A is a schematic view; and FIG. 5B is a sectional view taken at line 5B-5B of FIG. 5A;

FIG. 6 is a sectional view of another first electrochemical device precursor according to various aspects of the present disclosure;

FIG. 7 is a partial sectional view of yet another first electrochemical device precursor according to various aspects of the present disclosure, the first electrochemical device precursor including a bipolar current collector;

FIG. 8 is a partial sectional view of yet another first electrochemical device precursor according to various aspects of the present disclosure;

FIG. 9 is a schematic view of yet another first electrochemical device precursor according to various aspects of the present disclosure, the first electrochemical device precursor including a single pair of current collectors; and

FIGS. 10A-10B depict a second electrochemical device precursor formed from the first electrochemical device precursor of FIGS. 5A-5B; FIG. 10A is a schematic view; and FIG. 10B is a sectional view taken at line 10B-10B of FIG. 10A;

FIGS. 11A-11B depict a third electrochemical device precursor formed from the second electrochemical device precursor of FIGS. 10A-10B; FIG. 11A is a schematic view; and FIG. 11B is a sectional view taken at line 11B-11B of FIG. 11A;

FIG. 12 is a schematic view of a fourth electrochemical device precursor formed from the third electrochemical device precursor of FIGS. 11A-11B;

FIGS. 13A-13C relate to another electrochemical device according to various aspects of the present disclosure; FIG. 13A is a schematic view of a first sheet of a second electrochemical device precursor of the electrochemical device; FIG. 13B is a schematic view of a second sheet of the second electrochemical device precursor; and FIG. 13C is an exploded view of a fourth electrochemical device precursor of the electrochemical device, the fourth electrochemical device precursor including the first and second sheets; and

FIG. 14 is a schematic view of a electrochemical device formed from the fourth electrochemical device precursor of FIG. 12;

FIG. 15 is a schematic view of yet another electrochemical device according to various aspects of the present disclosure; and

FIG. 16 is a schematic view of yet another electrochemical device according to various aspects of the present disclosure.

FIG. 17 is a schematic view of yet another electrochemical device according to various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology pertains to rechargeable lithium-ion batteries, which may be used in vehicle applications. However, the present technology may also be used in other electrochemical devices that cycle lithium ions, such as handheld electronic devices. A rechargeable lithium-ion battery is provided that may exhibit both high energy density and high power density for fast charging.

A typical electrochemical cell includes a first electrode, such as a positive electrode or cathode, a second electrode such as a negative electrode or an anode, an electrolyte, and a separator. Often, in a lithium-ion battery pack, electrochemical cells are electrically connected in a stack to increase overall output. Lithium-ion electrochemical cells operate by reversibly passing lithium ions between the negative electrode and the positive electrode. The separator and the electrolyte are disposed between the negative and positive electrodes. The electrolyte is suitable for conducting lithium ions and may be in liquid, gel, or solid form. Lithium ions move from a positive electrode to a negative electrode during charging of the battery, and in the opposite direction when discharging the battery.

Each of the negative and positive electrodes within a stack is connected to a current collector (typically a metal, such as copper for the anode and aluminum for the cathode). During battery usage, the current collectors associated with the two electrodes are connected by an external circuit that allows current generated by electrons to pass between the negative and positive electrodes to compensate for transport of lithium ions.

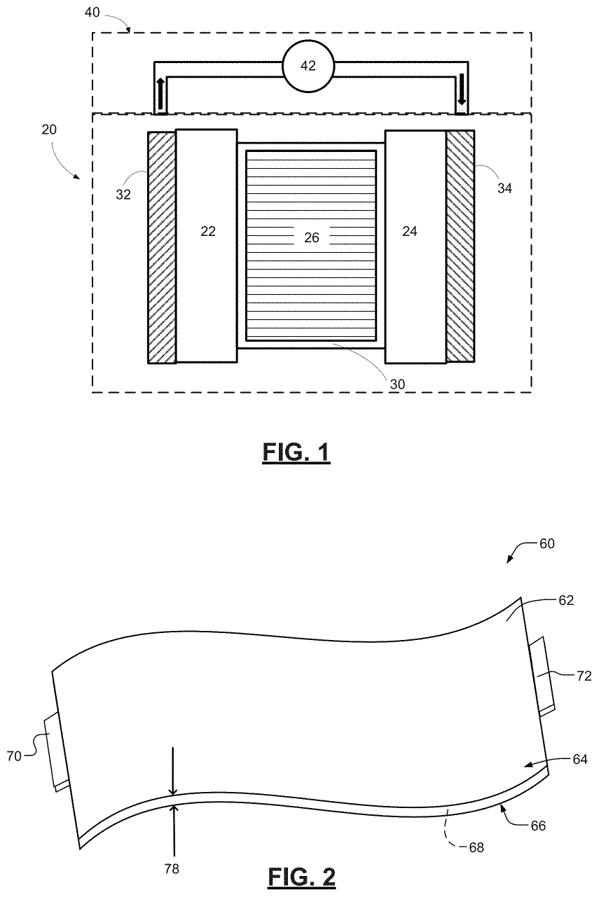

An exemplary schematic illustration of a lithium-ion battery 20 is shown in FIG. 1. The lithium-ion battery 20 includes a negative electrode 22, a positive electrode 24, and a porous separator 26 (e.g., a microporous or nanoporous polymeric separator) disposed between the negative and positive electrodes 22, 24. The porous separator 26 includes an electrolyte 30, which may also be present in the negative electrode 22 and positive electrode 24. A negative electrode current collector 32 may be positioned at or near the negative electrode 22 and a positive electrode current collector 34 may be positioned at or near the positive electrode 24. While not shown, the negative electrode current collector 32 and the positive electrode current collector 34 may be coated on one or both sides, as is known in the art. In certain aspects, the current collectors may be coated with an active material/electrode layer on both sides. The negative electrode current collector 32 and positive electrode current collector 34 respectively collect and move free electrons to and from an external circuit 40. An interruptible external circuit 40 having a load device 42 connects the negative electrode 22 (through the negative electrode current collector 32) and the positive electrode 24 (through the positive electrode current collector 34).

The porous separator 26 operates as both an electrical insulator and a mechanical support, by being disposed between the negative electrode 22 and the positive electrode 24 to prevent or reduce physical contact and thus, the occurrence of a short circuit. The porous separator 26, in addition to providing a physical barrier between the two electrodes 22, 24, can provide a minimal resistance path for internal passage of lithium ions (and related anions) during cycling of the lithium ions to facilitate functioning of the lithium-ion battery 20.

The lithium-ion battery 20 can generate an electric current during discharge by way of reversible electrochemical reactions that occur when the external circuit 40 is closed (to connect the negative electrode 22 and the positive electrode 24) when the negative electrode 22 contains a relatively greater quantity of cyclable lithium. The chemical potential difference between the positive electrode 24 and the negative electrode 22 drives electrons produced by the oxidation of lithium (e.g., intercalated lithium) at the negative electrode 22 through the external circuit 40 toward the positive electrode 24. Lithium ions, which are also produced at the negative electrode, are concurrently transferred through the electrolyte 30 and porous separator 26 towards the positive electrode 24. The electrons flow through the external circuit 40 and the lithium ions migrate across the porous separator 26 in the electrolyte 30 to intercalate into a positive electroactive material of the positive electrode 24. The electric current passing through the external circuit 40 can be harnessed and directed through the load device 42 until the intercalated lithium in the negative electrode 22 is depleted and the capacity of the lithium-ion battery 20 is diminished.

The lithium-ion battery 20 can be charged or re-energized at any time by connecting an external power source (e.g., charging device) to the lithium-ion battery 20 to reverse the electrochemical reactions that occur during battery discharge. The connection of an external power source to the lithium-ion battery 20 compels the intercalated lithium ions at the positive electrode 24 to move back toward the negative electrode 22. The electrons, which flow back towards the negative electrode 22 through the external circuit 40, and the lithium ions, which are carried by the electrolyte 30 across the separator 26 back towards the negative electrode 22, reunite at the negative electrode 22 and replenish it with lithium for consumption during the next battery discharge cycle. As such, each discharge and charge event is considered to be a cycle, where lithium ions are cycled between the positive electrode 24 and negative electrode 22.

The external power source that may be used to charge the lithium-ion battery 20 may vary depending on the size, construction, and particular end-use of the lithium-ion battery 20. Some notable and exemplary external power sources include, but are not limited to, AC power sources, such as an AC wall outlet and a motor vehicle alternator. A converter may be used to change from AC to DC for charging the battery 20. In many lithium-ion battery configurations, each of the negative electrode current collector 32, negative electrode 22, the separator 26, positive electrode 24, and positive electrode current collector 34 are prepared as relatively thin layers (for example, from several microns to a millimeter or less in thickness) and assembled in layers connected in electrical series and/or parallel arrangement to provide a suitable electrical energy and power package.

Furthermore, the lithium-ion battery 20 can include a variety of other components that while not depicted here are nonetheless known to those of skill in the art. For instance, the lithium-ion battery 20 may include a casing, gaskets, terminal caps, tabs, battery terminals, and any other conventional components or materials that may be situated within the battery 20, including between or around the negative electrode 22, the positive electrode 24, and/or the separator 26, by way of non-limiting example. As noted above, the size and shape of the lithium-ion battery 20 may vary depending on the particular application for which it is designed. Battery-powered vehicles and handheld consumer electronic devices, for example, are two examples where the lithium-ion battery 20 would most likely be designed to different size, capacity, and power-output specifications. The lithium-ion battery 20 may also be connected in series or parallel with other similar lithium-ion cells or batteries to produce a greater voltage output, energy, and power if it is required by the load device 42.

Accordingly, the lithium-ion battery 20 can generate electric current to a load device 42 that can be operatively connected to the external circuit 40. While the load device 42 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances, by way of non-limiting example. The load device 42 may also be a power-generating apparatus that charges the lithium-ion battery 20 for purposes of storing energy. In certain other variations, the electrochemical cell may be a supercapacitor, such as a lithium-ion based supercapacitor.

### Electrolyte

Any appropriate electrolyte 30, whether in solid, liquid, or gel form, capable of conducting lithium ions between the negative electrode 22 and the positive electrode 24 may be used in the lithium-ion battery 20. In certain aspects, the electrolyte 30 may be a non-aqueous liquid electrolyte solution that includes a lithium salt dissolved in an organic solvent or a mixture of organic solvents. Numerous conventional non-aqueous liquid electrolyte 30 solutions may be employed in the lithium-ion battery 20. Appropriate lithium salts generally have inert anions. A non-limiting list of lithium salts that may be dissolved in an organic solvent to form the non-aqueous liquid electrolyte solution include lithium hexafluorophosphate (LiPF₆); lithium perchlorate (LiClO₄); lithium tetrachloroaluminate (LiAlCl₄); lithium iodide (LiI); lithium bromide (LiBr); lithium thiocyanate (LiSCN); lithium tetrafluoroborate (LiBF₄); lithium difluorooxalatoborate (LiBF₂(C₂O₄)) (LiODFB), lithium tetraphenylborate (LiB(C₆H₅)₄); lithium bis-(oxalate)borate (LiB(C₂O₄)₂) (LiBOB); lithium tetrafluorooxalatophosphate (LiPF₄(C₂O₄)) (LiFOP), lithium nitrate (LiNO₃), lithium hexafluoroarsenate (LiAsF₆); lithium trifluoromethanesulfonate (LiCF₃SO₃); lithium bis(trifluoromethanesulfonimide) (LITFSI) (LiN(CF₃SO₂)₂); lithium fluorosulfonylimide (LiN(FSO₂)₂) (LIFSI); and combinations thereof In certain variations, the lithium salt is selected from LiPF₆, LiFSI, LiTFSI, and combinations thereof. An electrolyte may include a 1 M concentration of the lithium salts. In some embodiments, conventional electrolyte compositions can be used, such as a 1 molar solution of LiPF₆ in an organic solvent.

These lithium salts may be dissolved in a variety of organic solvents. In certain aspects, of the present teachings, the organic solvent is selected to be an organic ether compound. By way of example, ethers may include dimethyl ether, glyme (glycol dimethyl ether or dimethoxyethane (DME, e.g., 1,2-dimethoxyethane)), diglyme (diethylene glycol dimethyl ether or bis(2-methoxyethyl) ether), triglyme (tri(ethylene glycol) dimethyl ether), additional chain structure ethers, such as 1-2-diethoxyethane, ethoxymethoxyethane, 1,3-dimethoxypropane (DMP), cyclic ethers, such as tetrahydrofuran, 2-methyltetrahydrofuran, and combinations thereof. In certain variations, the organic ether compound is selected from the group consisting of: tetrahydrofuran, 2-methyl tetrahydrofuran, dioxolane, dimethoxy ethane (DME), diglyme (diethylene glycol dimethyl ether), triglyme (tri(ethylene glycol) dimethyl ether), 1,3-dimethoxypropane (DMP), and combinations thereof.

Carbonate-based solvents may include various alkyl carbonates, such as cyclic carbonates (e.g., ethylene carbonate, propylene carbonate, butylene carbonate) and acyclic carbonates (e.g., dimethyl carbonate, diethyl carbonate, ethyl methyl carbonate (EMC)). Ether-based solvents include cyclic ethers (e.g., tetrahydrofuran, 2-methyltetrahydrofuran, 1,3-dioxolane) and chain structure ethers (e.g., 1,2-dimethoxyethane, 1-2-diethoxyethane, ethoxymethoxyethane).

In various embodiments, appropriate solvents in addition to those described above may be selected from propylene carbonate, dimethyl carbonate, diethyl carbonate, methyl ethyl carbonate, y-butyrolactone, dimethyl sulfoxide, acetonitrile, nitromethane and mixtures thereof.

As will be discussed further below, where the electrolyte is a solid state electrolyte, it may include a composition selected from the group consisting of: LiTi₂(PO4)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S-P₂S₅, Li₆PS₅Cl, Li₆PS₅Br, Li₆PS₅I, Li₃OCl, Li_{2.99} Ba_{0.005}ClO, and combinations thereof.

### Separator

The porous separator 26 may include, in instances, a microporous polymeric separator including a polyolefin (including those made from a homopolymer (derived from a single monomer constituent) or a heteropolymer (derived from more than one monomer constituent)), which may be either linear or branched. In certain aspects, the polyolefin may be polyethylene (PE), polypropylene (PP), or a blend of PE and PP, or multi-layered structured porous films of PE and/or PP. Commercially available polyolefin porous separator 26 membranes include CELGARD® 2500 (a monolayer polypropylene separator) and CELGARD® 2340 (a trilayer polypropylene/polyethylene/polypropylene separator) available from Celgard LLC.

When the porous separator 26 is a microporous polymeric separator, it may be a single layer or a multi-layer laminate. For example, in one embodiment, a single layer of the polyolefin may form the entire microporous polymer separator 26. In other aspects, the separator 26 may be a fibrous membrane having an abundance of pores extending between the opposing surfaces and may have a thickness of less than a millimeter, for example. As another example, however, multiple discrete layers of similar or dissimilar polyolefins may be assembled to form the microporous polymer separator 26. The microporous polymer separator 26 may also include other polymers alternatively or in addition to the polyolefin such as, but not limited to, polyethylene terephthalate (PET), polyvinylidene fluoride (PVdF), polyamide (nylons), polyurethanes, polycarbonates, polyesters, polyetheretherketones (PEEK), polyethersulfones (PES), polyimides (PI), polyamide-imides, polyethers, polyoxymethylene (e.g., acetal), polybutylene terephthalate, polyethylenenaphthenate, polybutene, polymethyl pentene, polyolefin copolymers, acrylonitrile-butadiene styrene copolymers (ABS), polystyrene copolymers, polymethylmethacrylate (PMMA), polysiloxane polymers (such as polydimethylsiloxane (PDMS)), polybenzimidazole (PBI), polybenzoxazole (PBO), polyphenylenes, polyarylene ether ketones, polyperfluorocyclobutanes, polyvinylidene fluoride copolymers (e.g., PVdF—hexafluoropropylene or (PVdF-HFP)), and polyvinylidene fluoride terpolymers, polyvinylfluoride, liquid crystalline polymers (e.g., VECTRAN™ (Hoechst AG, Germany) and ZENITE® (DuPont, Wilmington, Del.)), polyaramides, polyphenylene oxide, cellulosic materials, meso-porous silica, and/or combinations thereof

Furthermore, the porous separator 26 may be mixed with a ceramic material or its surface may be coated in a ceramic material. For example, a ceramic coating may include alumina (Al₂O₃), silicon dioxide (SiO₂), or combinations thereof. Various conventionally available polymers and commercial products for forming the separator 26 are contemplated, as well as the many manufacturing methods that may be employed to produce such a microporous polymer separator 26.

### Solid-State Electrolyte (SSE)

In various aspects, the porous separator 26 and the electrolyte 30 may be replaced with a SSE that functions as both an electrolyte and a separator. The SSE may be disposed between a positive electrode and a negative electrode. The SSE enables transfer of lithium ions, while mechanically separating and providing electrical insulation between the negative and positive electrodes 22, 24. By way of non-limiting example, solid state electrolytes may include LiTi₂(PO4)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S-P₂S₅, Li₆PS₅Cl, Li₆PS₅Br, Li₆PS₅I, Li₃OCl, and Li_{2.99}Ba_{0.005}ClO.

### Positive Electrode

The positive electrode 24 may be formed from a lithium-based active material that can undergo lithium intercalation and deintercalation, alloying and dealloying, or plating and stripping, while functioning as the positive terminal of the battery 20. The positive electrode 24 electroactive materials may include one or more transition metals cations, such as manganese (Mn), nickel (Ni), cobalt (Co), chromium (Cr), iron (Fe), vanadium (V), and combinations thereof. Two exemplary common classes of known electroactive materials that can be used to form the positive electrode 24 are lithium transition metal oxides with layered structures and lithium transition metal oxides with spinel phase. For example, in certain instances, the positive electrode 24 may include a spinel-type transition metal oxide, like lithium manganese oxide (Li₍₁₊ₓ₎Mn₍₂₋ₓ₎O₄), where x is typically <0.15, including LiMn₂O₄ (LMO) and lithium manganese nickel oxide LiMn_{1.5}Ni_{0.5}O₄ (LMNO). In other instances, the positive electrode 24 may include layered materials like lithium cobalt oxide (LiCoO₂), lithium nickel oxide (LiNiO₂), a lithium nickel manganese cobalt oxide (Li(NiₓMn_{y}Co_{z})O₂), where 0≤x≤1, 0≤y≤1, 0≤z≤1, and x+y+z=1, including LiMn_{0.33}Ni_{0.33}Co_{0.33}O₂, a lithium nickel cobalt metal oxide (LiNi_{(1-x-y)}CoₓM_{y}O₂), where 0<x<1, 0<y<1 and M may be Al, Mn, or the like. Other known lithium-transition metal compounds such as lithium iron phosphate (LiFePO₄) or lithium iron fluorophosphate (Li₂FePO₄F) can also be used. In certain aspects, the positive electrode 24 may include an electroactive material that includes manganese, such as lithium manganese oxide (Li₍₁₊ₓ₎Mn₍₂₋ₓ₎O₄), a mixed lithium manganese nickel oxide (LiMn₍₂₋ₓ₎NiₓO₄), where 0≤x≤1, and/or a lithium manganese nickel cobalt oxide (e.g., LiMn_{0.33}Ni_{0.33}Co_{0.33}O₂). In a lithium-sulfur battery, positive electrodes may have elemental sulfur as the active material or a sulfur-containing active material.

The positive electrode 24 may further include a conductive carbon particle that may be a microcarbon or nanocarbon material. In certain aspects, the positive electrode 24 may have the electroactive material along with the conductive carbon. By microcarbon or nanocarbon, it is meant that electrically conductive particles may have an average particle size diameter within the microscale or nanoscale range.

A “microparticle” as used herein encompasses “nanoparticles,” as discussed below. In certain variations of the present teachings, a microparticle component has at least one spatial dimension that is less than about 1,000 μm (i.e., 1 mm). The term “micro-sized” or “micrometer-sized” as used herein is generally understood by those of skill in the art to mean less than about 500 μm (i.e., 0.5 mm), optionally less than or equal to about 100 μm (i.e., 0.1 mm), optionally less than about 10 μm (i.e., 10,000 nm), optionally less than about 5 μm (i.e., 5,000 nm), and optionally less than about 1 μm (i.e., 1,000 nm).

“Nano-sized” or “nanometer-sized” particles have at least one spatial dimension that is less than about 1 μm (i.e., 1,000 nm), optionally less than about 0.5 μm (i.e., 500 nm), optionally less than about 0.4 μm (i.e., 400 nm), optionally less than about 0.3 μm (i.e., 300 nm), optionally less than about 0.2 μm (i.e., 200 nm), and in certain variations, optionally less than about 0.1 μm (i.e., 100 nm). Accordingly, a nanoparticle component has at least one spatial dimension that is greater than about 1 nm and less than about 1,000 nm (1 μm).

The positive electrode 24 may include a polymeric binder material to fortify structurally the lithium-based active material. The positive electrode 24 electroactive materials may further include compounds that include one or more transition metal cations, such as manganese (Mn), nickel (Ni), cobalt (Co), chromium (Cr), iron (Fe), vanadium (V), and combinations thereof. However, in certain variations, the positive electrode 24 is free of select metal cations, such as nickel (Ni) and cobalt (Co).

Such electroactive materials may be intermingled with an optional electrically conductive material (e.g., particles) and at least one polymeric binder, for example, by slurry casting active materials and optional conductive material particles with such binders, like polyvinylidene fluoride (PVdF), poly(vinylidene chloride) (PVC), poly((dichloro-1,4-phenylene)ethylene), carboxymethoxyl cellulose (CMC), nitrile butadiene rubber (NBR), fluorinated urethanes, fluorinated epoxides, fluorinated acrylics, copolymers of halogenated hydrocarbon polymers, epoxides, ethylene propylene diamine termonomer rubber (EPDM), hexafluoropropylene (HFP), ethylene acrylic acid copolymer (EAA), ethylene vinyl acetate copolymer (EVA), EAA/EVA copolymers, PVDF/HFP copolymers, polyvinylidene difluoride (PVdF), lithium polyacrylate (LiPAA), sodium polyacrylate (NaPAA), sodium alginate, lithium alginate, and combinations thereof

Electrically conductive materials may include graphite, other carbon-based materials, conductive metals or conductive polymer particles. Carbon-based materials may include by way of non-limiting example, particles of KETCHEN™ black, DENKA™ black, acetylene black, carbon black, and the like. Conductive metal particles may include nickel, gold, silver, copper, aluminum, and the like. Examples of a conductive polymer include polyaniline, polythiophene, polyacetylene, polypyrrole, and the like. In certain aspects, mixtures of electrically conductive materials may be used. The positive electrode current collector 34 may be formed from aluminum or any other appropriate electrically conductive material known to those of skill in the art. As noted above, the positive electrode current collector 34 may be coated on one or more sides.

### Negative Electrode

The negative electrode 22 may include an electroactive material as a lithium host material capable of functioning as a negative terminal of a lithium-ion battery. Common negative electrode materials include lithium insertion materials or alloy host materials, like carbon-based materials, such as lithium-graphite intercalation compounds, or lithium-silicon compounds, lithium-tin alloys, and lithium titanate Li₄₊ₓTi₅O₁₂, where 0≤x≤3, such as Li₄Ti₅O₁₂ (LTO). Where the negative electrode 22 is made of metallic lithium, the electrochemical cell is considered a lithium-metal battery or cell. Metallic lithium for use in the negative electrode of a rechargeable battery has various potential advantages, including having the highest theoretical capacity and lowest electrochemical potential. Thus, batteries incorporating lithium-metal anodes can have a higher energy density that can potentially double storage capacity, so that the battery may be half the size, but still last the same amount of time as other lithium-ion batteries.

In certain variations, the negative electrode 22 may optionally include an electrically conductive material, as well as one or more polymeric binder materials to structurally hold the lithium material together. Negative electrodes may include about 50-100% by weight of an electroactive material (e.g., lithium particles or a lithium foil), and optionally ≤30% by weight of an electrically conductive material, and a balance binder. For example, in one embodiment, the negative electrode 22 may include an active material including lithium-metal particles intermingled with a binder material selected from the group consisting of: polyvinylidene difluoride (PVdF), ethylene propylene diene monomer (EPDM) rubber, carboxymethoxyl cellulose (CMC), a nitrile butadiene rubber (NBR), lithium polyacrylate (LiPAA), sodium polyacrylate (NaPAA), sodium alginate, lithium alginate, and combinations thereof. Suitable additional electrically conductive materials may include carbon-based material or a conductive polymer. Carbon-based materials may include by way of example, particles of KETCHEN™ black, DENKA™ black, acetylene black, carbon black, and the like. Examples of a conductive polymer include polyaniline, polythiophene, polyacetylene, polypyrrole, and the like. In certain aspects, mixtures of conductive materials may be used.

An electrode may be made by mixing the electroactive material into a slurry with a polymeric binder compound, a non-aqueous solvent, optionally a plasticizer, and optionally if necessary, electrically conductive particles. The slurry can be mixed or agitated, and then thinly applied to a substrate via a doctor blade. The substrate can be a removable substrate or alternatively a functional substrate, such as a current collector (such as a metallic grid or mesh layer) attached to one side of the electrode film. In one variation, heat or radiation can be applied to evaporate the solvent from the electrode film, leaving a solid residue. The electrode film may be further consolidated, where heat and pressure are applied to the film to sinter and calendar it. In other variations, the film may be dried at moderate temperature to form self-supporting films. If the substrate is removable, then it is removed from the electrode film that is then further laminated to a current collector. With either type of substrate, it may be necessary to extract or remove the remaining plasticizer prior to incorporation into the battery cell.

In other variations, a negative electrode 22 may be in the form of lithium metal, such as a lithium foil or lithium film. The lithium metal layer may be disposed on the negative electrode current collector 32.

### Optional Electrode Surface Coatings

In certain variations, pre-fabricated electrodes formed of electroactive material via the active material slurry casting described above can be directly coated via a vapor coating formation process to form a conformal inorganic-organic composite surface coating, as described further below. Thus, one or more exposed regions of the pre-fabricated negative electrodes including the electroactive material can be coated to minimize or prevent reaction of the electrode materials with components within the electrochemical cell to minimize or prevent lithium metal dendrite formation on the surfaces of negative electrode materials when incorporated into the electrochemical cell. In other variations, a plurality of particles including an electroactive material, like lithium metal, can be coated with an inorganic-organic composite surface coating. Then, the coated electroactive particles can be used in the active material slurry to form the negative electrode, as described above.

### Electrode Construction

The positive electrode active compositions generally are powder compositions that are held together in the corresponding electrode with a polymer binder. The binder provides ionic conductivity to the active particles when in contact with the electrolyte. Suitable polymer binders were described above and include, for example, polyvinylidene fluoride (PVDF), polyethylene oxide, polyethylene, polypropylene, polytetrafluoroethylene, polyacrylates, rubbers, e.g., ethylene-propylene-diene monomer (EPDM) rubber or styrene butadiene rubber (SBR), copolymers thereof and mixtures thereof. The positive electrode active material loading in the binder can be large, such as greater than about 80% by weight. For example, the binder can be present at a level of greater than or equal to about 1% by weight to less than or equal to about 20% by weight, or more narrowly greater than or equal to about 1% by weight to less than or equal to about 10% by weight, greater than or equal to about 1 to less than or equal to about 8% by weight, greater than or equal to about 1% by weight to less than or equal to about 6% by weight, greater than or equal to about 1% by weight to less than or equal to about 7% by weight, greater than or equal to about 1% by weight to less than or equal to about 5% by weight, and optionally greater than or equal to about 1% by weight to less than or equal to about 3% by weight binder. To form the electrode, the powders can be blended with the polymer in a suitable liquid, such as a solvent for the polymer. The resulting paste can be pressed into the electrode structure.

As described above, the positive electrode composition may also include an electrically conductive powder distinct from the electroactive composition, as discussed above. While the metal alloy/intermetallic compositions described herein generally provide for electrical conductivity within the negative electrode structure, the negative electrode can optionally further include supplemental electrically conductive powders, such as the conductive powders above. In some embodiments, the negative electrode includes less than or equal to about 15% by weight supplemental electrically conductive powders, in other embodiments less than or equal to about 10% by weight, and in additional embodiments from greater than or equal to about 0.5% by weight to less than or equal to about 8% by weight supplemental electrically conductive powders. While the supplemental electrically conductive compositions are described as powders, these materials lose their powder character following incorporation into the electrode where the associated particles of the supplemental electrically conductive material become a component of the resulting electrode structure.

### Current Collectors

The positive electrode and negative electrodes generally are associated with an electrically conductive current collector to facilitate the flow of electrons between the electrode and an exterior circuit. The current collector can include metal, such as a metal foil, a metal grid or screen, or expanded metal. Expanded metal current collectors refer to metal grids with a greater thickness such that a greater amount of electrode material is placed within the metal grid. In some embodiments, the current collector can be formed from nickel, aluminum, stainless steel, titanium or the like. The electrode material can be cast in contact with the current collector.

The positive electrode current collector 34 may be formed from aluminum or any other appropriate electrically conductive material known to those of skill in the art. The negative electrode current collector 32 may be formed from copper or any other appropriate electrically conductive material known to those of skill in the art. The negative electrode current collector 32 may be a copper collector foil.

Electrodes can generally be incorporated into various commercial battery designs, such as prismatic shaped cells, wound cylindrical cells, coin cells, pouch cells or other reasonable cell shapes. The cells can include a single electrode structure of each polarity or a stacked structure with a plurality of positive electrodes and negative electrodes assembled in parallel and/or series electrical connections. In particular, the battery can include a stack of alternating positive electrodes and negative electrodes with separators between them. Generally, the plurality of electrodes is connected in parallel to increase the current at the voltage established by a pair of a positive electrode and a negative electrode. While the positive electrode active materials can be used in batteries for primary, or single charge use, the resulting batteries generally have desirable cycling properties for secondary battery use over multiple cycling of the cells.

At least partially due to the quantity of layers, many of the above battery structures may be prone to mechanical loading and are inflexible. The inflexibility gives rise to packaging limitations when the battery is used in a device or vehicle. Furthermore, many commercial batteries include cells that are electrically connected in parallel and are therefore limited to a voltage of less than or equal to about 4 volts based on an electrochemical potential of the electroactive materials. To achieve higher voltages and currents, several batteries may be connected via secondary electrical connections. These secondary joints are generally present outside of a housing and can cause higher resistance to current flow. Secondary connections can also add complexity and increase processing time. Furthermore, it is not always possible to conform secondary connections to a space in which the battery is used. Accordingly, less than all of the available space might may be utilized, which can negatively impact the total energy density of the connected batteries.

### Thin, Conformable Electrochemical Devices

In various aspects, the present disclosure provides a thin, conformable electrochemical device. In certain aspects, the electrochemical device may be a battery. The electrochemical device includes a flexible housing containing a plurality of electrochemical cells within a single interior region. The electrochemical cells may be connected in series and/or parallel to meet the current and voltage requirements of a system. Multiple current collectors may be disposed on a single plane of the housing. Current collectors may be directly connected to one another to form the series and parallel connections between adjacent electrochemical cells. Thus, in certain aspects, the present disclosure provides a high-voltage and/or high-current battery within a single flexible package.

In certain aspects, electrochemical devices according to the present disclosure may be customizable in terms of voltage, current, and packaging shape. Battery voltage can be adjusted by adjusting a quantity of serially-connected electrochemical cells within a housing. Furthermore, total voltage can be increased while maintaining a constant housing footprint by decreasing size of the electrochemical cells and increasing a quantity of the electrochemical cells. Total current can be adjusted by adjusting a quantity of parallel-connected electrochemical cells within the housing and/or adjusting a cross-sectional area of terminals and/or current collectors of the battery. In various aspects, multiple thin, conformable electrochemical devices can be electrically connected via secondary electrical connections to further increase current and/or voltage output.

In certain aspects, electrochemical devices according to the present disclosure are conformable such that they can be bent, folded, or twisted to fit within a desired space without significantly impacting performance or otherwise suffering damage. Because several electrochemical cells can be electrically connected within a single housing, electrochemical devices according to certain aspects of the present disclosure may require fewer secondary or external electrical connections compared to existing electrochemical devices. Accordingly, the electrochemical devices may have decreased resistance and faster response time than existing electrochemical device systems. Furthermore, electrochemical devices may be more resistant to wear at electrical joints, leading to improved life and improved performance throughout life.

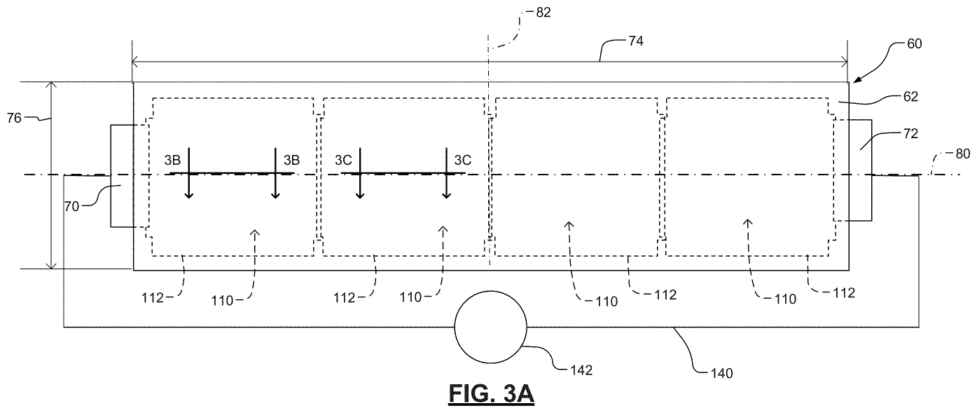

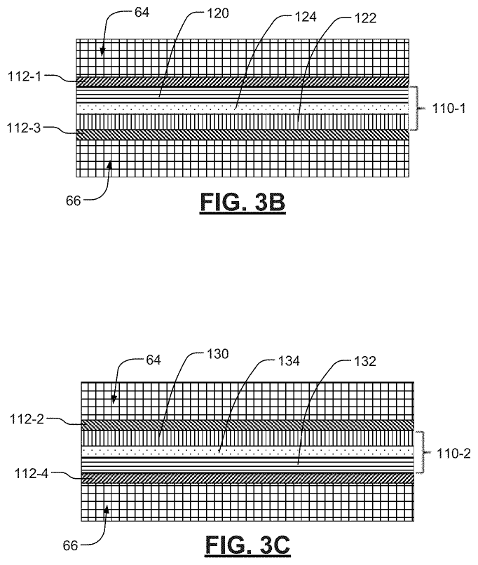

Referring to FIGS. 2-3C, a thin, conformable electrochemical device 60 according to various aspects of the present disclosure is provided. The electrochemical device 60 includes an electrically-insulating housing 62. The housing 62 includes a first film portion 64 and a second film portion 66. The first and second film portions 64, 66 are coupled to one another to at least partially define an interior region 68 (FIG. 2). The first and second film portions 64, 66 may be portions of a larger sheet, such as a sheet that is folded over and sealed to itself during manufacturing, or may be separate sheets that are sealed together during manufacturing of the electrochemical device 60. A positive terminal 364 and a negative terminal 72 extend from the interior region 68 to an exterior region of the electrochemical device 60.

The housing 62 may be formed from one or more flexible sheets. For example, the housing 62 may include the first film portion 64 and the second film portion 66. The housing 62 may include an electrically insulating material. In certain aspects, the electrically-insulating material may include polyethylene terephthalate (PET), polyamide (nylons), polyurethanes, polycarbonates, polyesters, polyetheretherketones (PEEK), polyethersulfones (PES), polyimides (PI), polyamide-imides, polyethers, polyoxymethylene (e.g., acetal), polybutylene terephthalate, polyethylenenaphthenate, polybutene, polymethylpentene, polyolefin copolymers, polymethylmethacrylate (PMMA), and polyaramides, by way of example. In certain aspects, the housing 62 may consist essentially of the electrically-insulating material.

In various aspects, the housing 62 may be referred to as a “planar housing” because it defines a first dimension or length 74 (FIG. 3A) and a second dimension or width 76 (FIG. 3A) that are each substantially greater than a third dimension or thickness 78 (FIG. 2). The length 74 and width 76 are not particularly limited and may be adjusted based on packaging requirements of a system in which the electrochemical device 60 will be used, and in certain aspects, desired total voltage and/or current. The thickness 78 may range from greater than or equal to about 0.1 mm to less than or equal to about 2 mm (e.g., greater than or equal to about 0.1 mm to less than or equal to about 0.5 mm, greater than or equal to about 0.5 mm to less than or equal to about 1 mm, or greater than or equal to about 1 mm to less than or equal to about 2 mm). In certain aspects, the thickness may be less than or equal to about 2 mm, optionally less than or equal to about 1.5 mm, optionally less than or equal to about 1 mm, optionally less than or equal to about 0.8 mm, optionally less than or equal to about 0.6 mm, optionally less than or equal to about 0.4 mm, or optionally less than or equal to about 0.2 mm. In some examples, such as when the electrochemical device 60 will be used in vehicles or secondary use applications, the length 74 may range from greater than or equal to about 50 mm to less than or equal to about 2000 mm (e.g., greater than or equal to about 50 mm to less than or equal to about 100 mm, greater than or equal to about 100 mm to less than or equal to about 200 mm, greater than or equal to about 200 mm to less than or equal to about 500 mm, greater than or equal to about 500 mm to less than or equal to about 1000 mm, or greater than or equal to about 1000 mm to less than or equal to about 2000 mm) and the width 76 may range from greater than or equal to about 50 mm to less than or equal to about 2000 mm (e.g., greater than or equal to about 50 mm to less than or equal to about 100 mm, greater than or equal to about 100 mm to less than or equal to about 200 mm, greater than or equal to about 200 mm to less than or equal to about 500 mm, greater than or equal to about 500 mm to less than or equal to about 1000 mm, or greater than or equal to about 1000 mm to less than or equal to about 2000 mm). In other examples, such as when the electrochemical device 60 will be used in electronics and medical applications, the length 74 and width 76 may each be less than or equal to about 200 mm, optionally less than or equal to about 100 mm, optionally less than or equal to about 50 mm, optionally less than or equal to about 25 mm, optionally less than or equal to about 10 mm, optionally less than or equal to about 5 mm, or optionally less than or equal to about 1 mm. Although the housing 62 is shown as being substantially rectangular, its shape is not particularly limited and may define other shapes substantially perpendicular to its thickness 78.

In various aspects, the electrochemical device 60 may be conformable such that it can be bent, folded, or twisted to fit within the system. The electrochemical device 60 may be configured to be bent along any axis substantially perpendicular to its thickness 78. For example, the electrochemical device 60 may be bendable parallel to a first axis 80 substantially parallel to its length 74 and a second axis 82 substantially parallel to its width 76. The first and second axes 80, 82 may be substantially perpendicular to one another. In certain aspects, the electrochemical device 60 is configured to be bent about any axis in a plane defined by the first and second axes 80, 82. In one example, the electrochemical device 60 is configured to conform to an outer surface of an adjacent component in the system. In another example, the electrochemical device 60 is curved to fit within a gap between components. In yet another example, the electrochemical device 60 is folded to fit into a space having dimensions smaller than its length 74 and width 76.

The electrochemical device 60 may include a plurality of electrochemical cells 110. The plurality of electrochemical cells 110 may include at least a first electrochemical cell 110-1 (FIG. 3B) and a second electrochemical cell 110-2 (FIG. 3C). In the example shown, the electrochemical device 60 includes four electrochemical cells; however, other quantities of electrochemical cells 110 are also contemplated. In certain aspects a quantity of electrochemical cells may be one. In other non-limiting examples, a quantity of electrochemical cells may be greater than or equal to two, optionally greater than or equal to four, optionally greater than or equal to eight, optionally greater than or equal to ten, optionally greater than or equal to twenty-five, optionally greater than or equal to fifty, optionally greater than or equal to one hundred, optionally greater than or equal to two hundred, or optionally greater than or equal to five hundred electrochemical cells. The electrochemical cells 110 are electrically connected to one another. Electrical connections between the electrochemical cells 110 may include series electrical connections, parallel electrical connections, or both series and parallel electrical connections.

The electrochemical device 60 further includes a plurality of current collectors 112 directly connected to the housing 62. More particularly, each electrochemical cell 110 is electrically connected to a pair of current collectors 112 (e.g., a positive electrode current collector and a negative electrode current collector). The current collectors 112 each include an electrically-conductive material. The current collectors 112 may include different electrically-conductive materials. For example, current collectors 112 associated with negative electrodes may include copper and current collectors 112 associated with positive electrodes may include aluminum, as described above in conjunction with FIG. 1. In certain aspects, a first portion of the plurality of current collectors 112 may be disposed within a common plane on an inside surface of the first film portion 64. A second portion of the plurality of current collectors 112 may be disposed within another common plane on an inside surface of the second film portion 66.

With reference to FIGS. 3A-3C, the plurality of current collectors 112 may include at least a first current collector 112-1, a second current collector 112-2, a third current collector 112-3, and a fourth current collector 112-4 (FIGS. 3B-3C). The first and second current collectors 112-1, 112-2 may be coupled to the first film portion 64 of the housing 62 and the third and fourth current collectors 112-3, 112-4 may be coupled to the second film portion 66 of the housing 62. In certain aspects, plurality of current collectors 112 may be directly coupled to the housing 62 without an adhesive disposed therebetween.

With reference to FIG. 3B, the first electrochemical cell 110-1 includes a first electrode 120, which may be a first negative electrode including a negative electrode material, and a second electrode 122, which may be a first positive electrode including a positive electrode material. The first electrochemical cell 110-1 may further include a first separator 124, such as a microporous or nanoporous polymeric separator or a solid-state electrolyte (SSE). If the first separator 124 is not a solid-state electrolyte, then the first electrochemical cell 110-1 may further include a liquid or gel electrolyte (not shown) disposed between the first and second electrodes 120, 122 and within the first separator 124. The liquid or gel electrolyte may also be present in the first electrode 120 and/or the second electrode 122.

The first current collector 112-1 may be disposed between the first electrode 120 and the first film portion 64 of the housing. The first current collector 112-1 may, in certain aspects, be a first negative electrode current collector. The third current collector 112-3 may be disposed between the second electrode 122 and the second film portion 66. The third current collector 112-3 may, in certain aspects, be a first positive electrode current collector. In certain aspects, the first and second electrodes 120, 122 may be directly coupled to the respective first and third current collectors 112-1, 112-3 without a distinct adhesive layer disposed therebetween. In one example, the first current collector 112-1 includes copper and the third current collector 112-3 includes aluminum. However, the first and third current collectors 112-1, 112-3 may include other electrically-conductive materials, such as those described above in conjunction with FIG. 1.

With reference to FIG. 3C, the second electrochemical cell 110-2 includes a third electrode 130, which may be a second positive electrode including the positive electrode material, and a fourth electrode 132, which may be a second negative electrode including the negative electrode material. The second electrochemical cell 110-2 may further include a second separator 134, such as a microporous or nanoporous polymeric separator or a solid-state electrolyte. If the second separator 134 is not a solid-state electrolyte, then the second electrochemical cell 110-2 may further include a liquid or gel electrolyte (not shown) disposed between the third and fourth electrodes 130, 132 and within the second separator 134. The liquid or gel electrolyte may also be present in the third electrode 130 and/or the fourth electrode 132.

The second current collector 112-2 may be disposed between the third electrode 130 and the first film portion 64 of the housing. The third current collector 112-3 may, in certain aspects, be a second positive electrode current collector. The fourth current collector 112-4 may be disposed between the fourth electrode 132 and the second film portion 66. The fourth current collector 112-4 may, in certain aspects, be a first negative electrode current collector. In certain aspects, the third and fourth electrodes 130, 132 may be directly coupled to the respective second and fourth current collectors 112-2, 112-4 without a distinct adhesive layer disposed therebetween. In one example, the second current collector 112-2 includes aluminum and the fourth current collector 112-4 includes copper. However, the second and fourth current collectors 112-2, 112-4 may include other electrically-conductive materials, such as those described above in conjunction with FIG. 1.

In various aspects, each electrochemical cell 110 may be formed form the same materials. More particularly, the first and fourth electrodes 120, 132 may be formed from the same negative electroactive material, the second and third electrodes 122, 130 may be formed from the same positive electroactive material, and the first and second separators 124, 134 may include the same material. However, in alternative aspects, the plurality of electrochemical cells 110 may include cells formed from different electroactive materials and/or separator materials. For example, the electrochemical device 60 may include both power cells (i.e., batteries) and energy cells (i.e., capacitors). Thus, the electrochemical device 60 may include the electrochemical cells 110 having different electroactive materials and/or separators within the housing 62.

In one example, the plurality of electrochemical cells may be connected in series. An interruptible external circuit 140 including a load 142 connects the positive terminal 70 and the negative terminal 72. Each electrochemical cell 110 may have a voltage of about 4 volts. Thus, the electrochemical device 60 may have a voltage of about 16 volts. It should be appreciated that, in addition to including other quantities of electrochemical cells 110, the electrochemical device 60 may also include different sizes of electrochemical cells, different shapes of electrochemical cells, different arrangements of positive and negative terminals, and different electrical connections between electrochemical cells 110.

Methods of Manufacturing Thin, Conformable Electrochemical devices

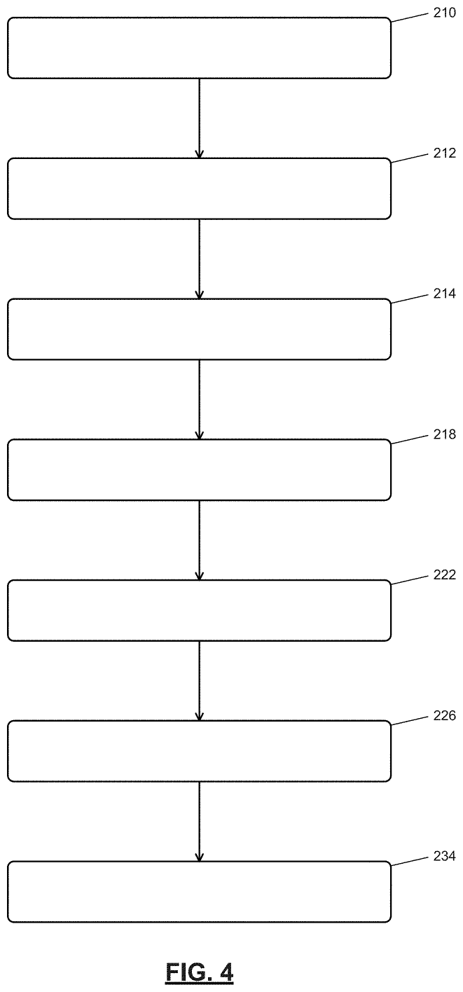

In various aspects, the present disclosure provides a method of manufacturing a thin, conformable electrochemical device, such as a battery. With reference to FIG. 4, the method generally includes: forming a first electrochemical device precursor at 210, forming electrical connections at 212, forming a second electrochemical device precursor at 214, forming a third electrochemical device precursor at 218, coupling positive and negative terminals to the electrochemical cells at 222, forming a fourth electrochemical device precursor at 226, and forming the electrochemical device at 234.

### Forming the First Electrochemical device Precursor

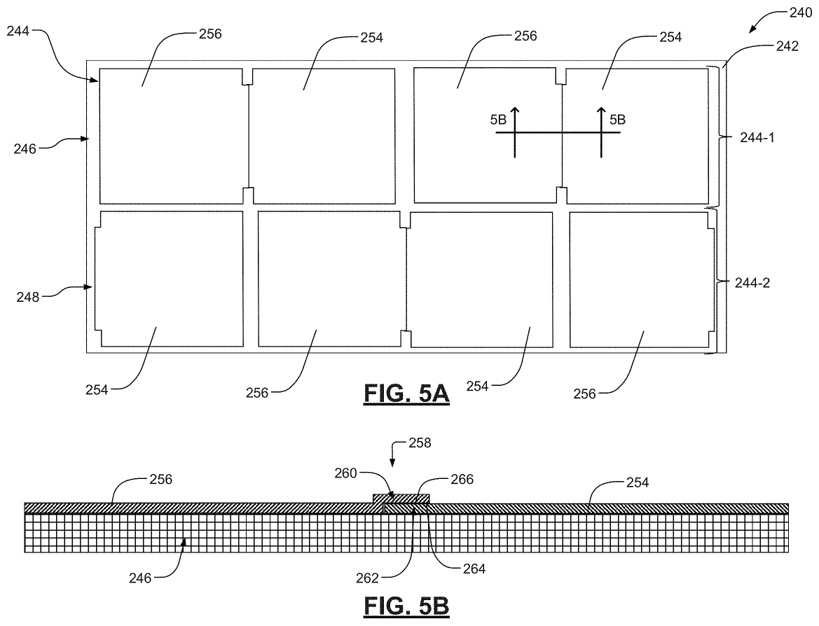

At step 210, the method includes forming a first electrochemical device precursor. With reference to FIGS. 5A-5B, a first electrochemical device precursor 240 including a housing 242 and a plurality of current collectors 244 is provided. The housing 242 may include a first film portion 246 and a second film portion 248. The plurality of current collectors 244 is coupled to the housing 242. More particularly, a first portion 244-1 of the plurality of current collectors 244 is disposed on the first film portion 246 and a second portion 244-2 of the plurality of current collectors 244 is disposed on the second film portion 248. The plurality of current collectors 244 may include positive electrode current collectors 254 and negative electrode current collectors 256. The current collectors 244 may be disposed in a checkerboard pattern, with positive and negative electrode current collectors 254, 256 being alternatingly disposed in a four-by-two grid. However, it should be appreciated that the current collectors 244 may have other arrangements depending on the desired series and/or parallel electrical connections between electrochemical cells 110 (FIG. 2). The first portion of the plurality of current collectors 244-1 may be disposed on a common plane (i.e., a surface of the first film portion 246) and the second portion of the plurality of current collectors 244-2 may be disposed on another common plane (i.e., a surface of the second film portion 248). In various aspects, in the first electrochemical device precursor 240, the plurality of current collectors 244 may be disposed on a single common plane.

In various aspects, forming the first electrochemical device precursor 240 includes coupling the current collectors 244 to the housing 242. Coupling the current collectors 244 to the housing 242 may include additive or subtractive techniques. Additive techniques may include plasma deposition, physical vapor deposition (PVD), electroless deposition (e.g., when the current collectors 244 include nickel), or printing, by way of example. Thus, the current collectors 244 may be formed and concurrently coupled to the housing 242 in situ. In certain aspects, coupling the current collectors 244 to the housing 242 includes plasma-depositing the current collectors 244 onto the housing 242. A subtractive technique may include pre-disposing a suitable electrically-conductive material (e.g., copper, aluminum) onto the housing 242, such as by lamination, and then performing etching to remove a portion of the electrically-conductive material and form the current collectors 244. In certain aspects, the current collectors 244 may be deposited directly onto a surface of the housing 242 so that the current collectors 244 are in direct contact with the housing 242. In various alternative aspects, the current collectors 244 may be formed prior coupling with the housing 242. The pre-formed current collectors 244 may then be coupled the housing 242 at step 210.

### Forming Electrical Connections Concurrently with Forming the First Precursor

In various aspects, such as when the current collectors 244 are formed in situ, step 212 may be performed concurrently with step 210. At step 212, forming electrical connections may include forming joints between certain current collectors 244, depending on desired series and/or parallel electrical connections. In various aspects, step 212 may be described as “electrically connecting the electrochemical cells.”

With reference to FIG. 5B, a joint 258 is formed between the negative electrode current collector 256 and the positive electrode current collector 254. In certain aspects, a first region 260 of the negative electrode current collector 256 may extend over a second region 262 of the positive electrode current collector 254. A bottom surface 264 of the first region 260 of the negative electrode current collector 256 may be in direct contact with a top surface 266 of the second region 262 of the positive electrode current collector 254. Thus, the second region 262 may be disposed between the first region 260 and the first film portion 246. In certain aspects, the joint 258 may be free of an additional joining material. In various aspects, a similar joint may be formed between two adjacent positive electrode current collectors or two negative electrode current collectors.

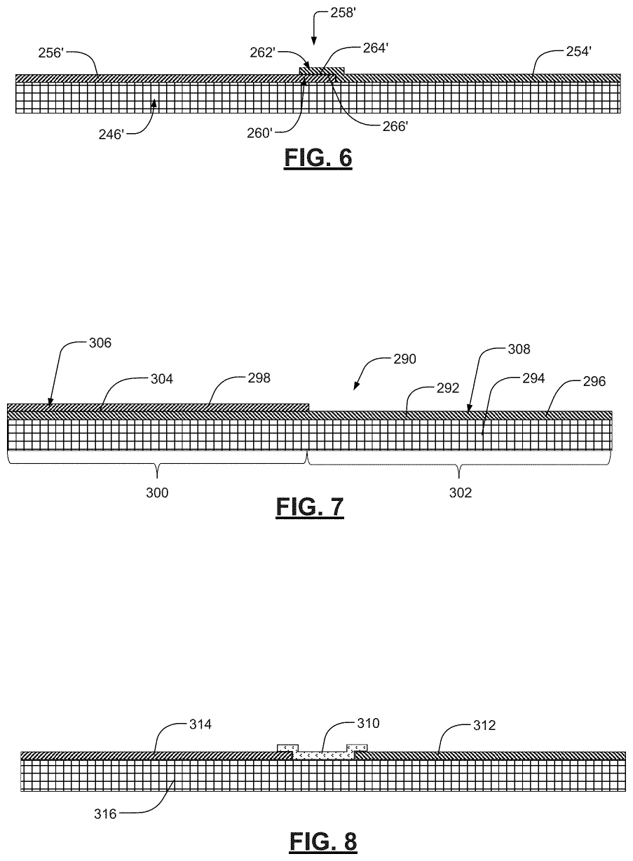

With reference to FIG. 6, another joint 258′ according to various aspects of the present disclosure is provided. The joint 258′ is formed between a positive electrode current collector 254′ and a negative electrode current collector 256′. A first region 260′ of the negative electrode current collector 256′ is disposed under a second region 262′ of the positive electrode current collector 254′. Thus, the first region 260′ is disposed between the second region 262′ and a first film portion 246′. A top surface 264′ of the first region 260′ may directly contact a bottom surface 266′ of the second region 262′. In certain aspects, the joint 258′ may be free of an additional joining material.

In various aspects, the present disclosure provides a bipolar current collector that is free of joints and seams, and a method of making the bipolar current collector. With reference to FIG. 7, a bipolar current collector 290 according to various aspects of the present disclosure is provided. The bipolar current collector 290 is disposed on a first surface 292 of a housing 294. The bipolar current collector 290 includes a first layer 296 including a first electrically conductive material and a second layer 298 including a second electrically conductive material distinct from the first electrically conductive material. In certain aspects, the first electrically conductive material may include aluminum and the second electrically conductive material may include copper.

The first layer 296 may be disposed directly on the first surface 292 of the housing 294. The first layer 296 may extend across both a first region 300 and a second region 302 of the housing 294. The first and second regions 300, 302 may be directly adjacent to one another. The second layer 298 may be disposed directly on a second surface 304 of the first layer 296 such that the first layer 296 is disposed between the housing 294 and a portion of the second layer 298. The bipolar current collector 290 may include a first current collector portion 306 (e.g., a negative electrode current collector) disposed in the first region 300 and a second current collector portion 308 (e.g., a positive electrode current collector) disposed in the second region 302.

Accordingly, when an electrochemical device includes one or more bipolar current collectors, step 210 may include forming the bipolar current collector(s). Step 210 may include forming the first layer 296 on the housing 294 in the first and second regions 300, 302, and forming the second layer 298 on the first layer 296 in the first region 300. Forming may include printing or plasma-depositing, by way of example. Step 212 (forming electrical connections) may be performed concurrently with step 210 (forming the first electrochemical device precursor 240).

### Forming Electrical Connections after Forming the First Precursor

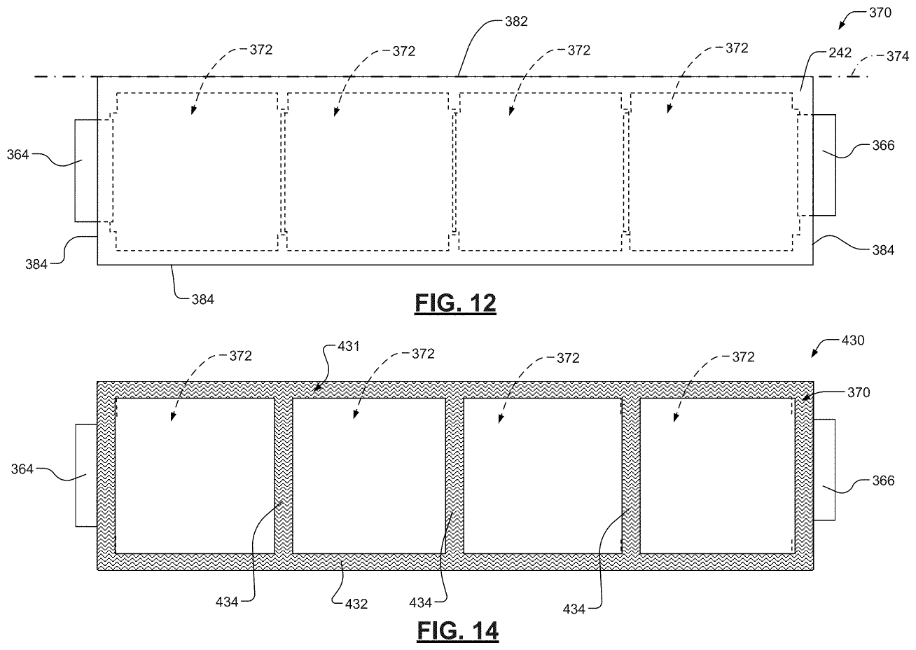

In various aspects, forming electrical connections (step 212) may be performed at some point after the completion of forming the first electrochemical device precursor 240 (step 210) and before forming the electrochemical device (step 234). Thus, the current collectors 244 may be joined to ultimately electrically connect electrochemical cells (see electrochemical cells 372 of FIG. 12) (step 212) in a separate operation from forming the first electrochemical device precursor (step 210). Forming electrical connections (step 212) may be performed after forming the first electrochemical device precursor 240 (step 210) when the current collectors 244 are not in direct contact with one another, such as when the current collectors 244 are formed prior to coupling with the housing 242, for example. A joint may be formed by at least one of printing (e.g., conductive ink), plasma-depositing, electrically-conductive adhesive bonding, welding, laser joining, resistance joining, or soldering.

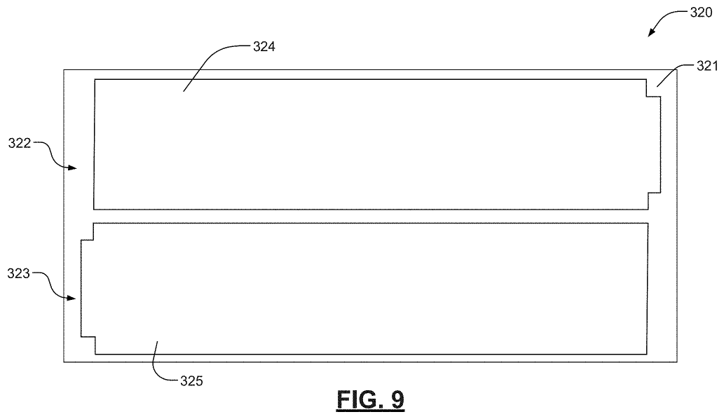

Referring to FIG. 8, yet another joint 310 according to various aspects of the present disclosure is provided. The joint 310 electrically connects a first current collector 312 and a second current collector 314 that are each coupled to a housing 316. The first and second current collectors 312, 314 may be independently selected from a positive electrode current collector and a negative electrode current collector, depending on the desired series and/or parallel arrangement of electrochemical cells. The first and second current collectors 312, 314 are spaced apart and are therefore not in direct contact with one another. The joint 310 is formed from an electrically conductive material to electrically connect the first and second current collectors 312, 314.

### Omitting Forming Electrical Connections

In various aspects, an electrochemical device may include a single pair of current collectors and step 212 may be omitted. With reference to FIG. 9, an electrochemical device 320 according to various aspects of the present disclosure is provided. The electrochemical device 320 includes an electrically-insulating housing 321 having a first film portion 322 and a second film portion 323. A first current collector, such as a positive electrode current collector 324, is coupled to the first film portion 322. A second current collector, such as a negative electrode current collector 325, is coupled to the second film portion 323.

### Forming the Second Electrochemical device Precursor

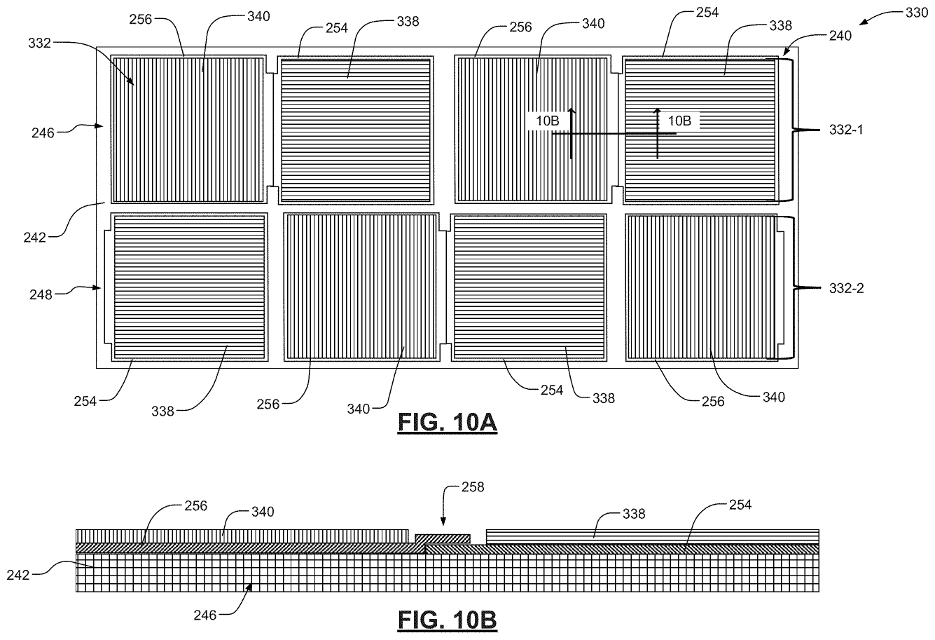

Returning to FIG. 4, at step 214, the method may further include forming a second electrochemical device precursor. With reference to FIGS. 10A-10B, a second electrochemical device precursor 330 according to various aspects of the present disclosure is provided. The second electrochemical device precursor 330 may include the first electrochemical device precursor 240 and a plurality of electrodes 332. A third portion 332-1 of the plurality of electrodes 332 may be disposed on the first portion 244-1 of the plurality of current collectors 244, respectively, on the first film portion 246 (FIGS. 5A-5B). A fourth portion 332-2 of the plurality of electrodes 332 may be disposed on the second portion 244-2 of the plurality of current collectors 244, respectively, on the second film portion 248 (FIGS. 5A-5B). In certain aspects, the electrodes 332 may be in direct contact with the current collectors 244.

The plurality of electrodes 332 may include first electrodes (e.g., positive electrodes) 338 and second electrodes (e.g., negative electrodes) 340. The positive electrodes 338 may be disposed on respective positive electrode current collectors 254 and the negative electrodes 340 may be disposed on respective negative electrode current collectors 256. The positive electrodes 338 may include a positive electroactive material, such as those described above in conjunction with the positive electrode 24 of FIG. 1. The negative electrode 340 may include a negative electroactive material, such as those described above in conjunction with the negative electrode 22 of FIG. 1.

Forming the second precursor 330 may including disposing the electrodes 332 on respective current collectors 244. In various aspects, the electrodes 332 may be formed in situ. The electrodes 332 may be formed by casting an electrode slurry onto the current collectors 244, electrostatic spray deposition, spray painting, sputter deposition, and/or pulsed laser deposition, by way of example. The electrodes 332 may be printed or deposited directly onto the respective current collectors. In various alternative aspects, the electrodes 332 may be formed prior to step 214, and disposed on the current collectors 244 at step 214. When the electrodes 332 are formed prior to step 214, the method may further include coupling the electrodes 332 to the respective current collectors 244, such as with additional binder material.

### Forming the Third Electrochemical device Precursor

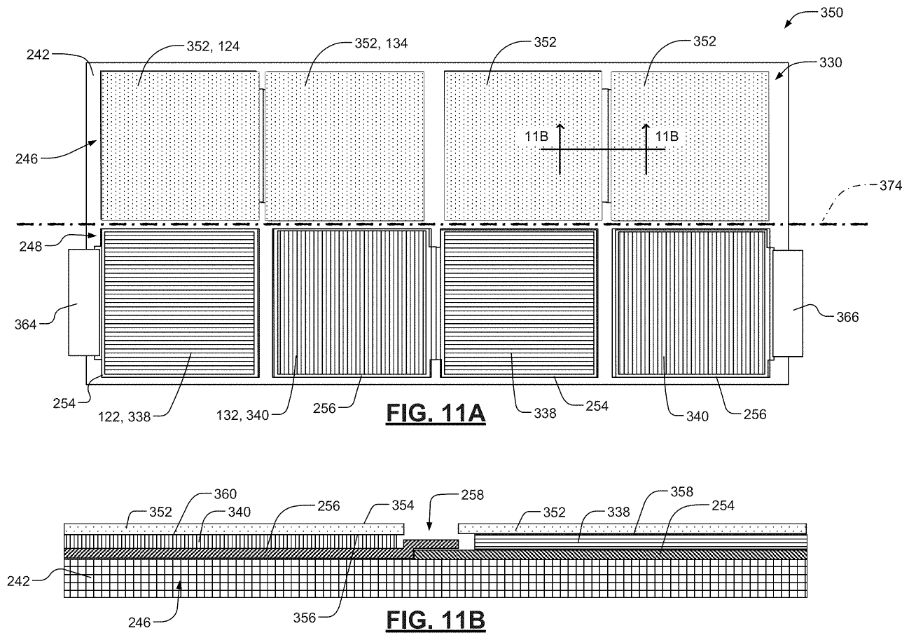

Returning to FIG. 4, at step 218, the method may further include forming a third electrochemical device precursor. With reference to FIGS. 11A-11B, a third electrochemical device precursor 350 according to various aspects of the present disclosure is provided. The third electrochemical device precursor 350 includes the second electrochemical device precursor 330 and a plurality of separators 352.

Forming the third electrochemical device precursor 350 may include disposing separators on at least a fifth portion of the electrodes 332. The fifth portion of the plurality of electrodes 332 may be coextensive with the third or fourth portions 332-1, 332-2, the fifth portion may be distinct from the third and fourth portions 332-1, 332-2, or the fifth portion may overlap with the third and or fourth portions 332-1, 332-2. In certain aspects, the fifth portion of the electrodes 332 may be coextensive with the third portion 332-1 of the plurality of electrodes 332 or the fourth portion 332-2 of the plurality of electrodes 332. In certain aspects, the fifth portion may include every electrode of the plurality of electrodes 332. In certain other aspects, the fifth portion may include each positive electrode 338 of the plurality of electrodes 332 or each negative electrode 340 of the plurality of electrodes 332. In still other aspects, the fifth portion may include a different subset of the electrodes 332. The separators 352 may be arranged so that each subsequently formed electrochemical cell (see electrochemical cells 372 of FIG. 12) includes at least one separator 352.

The separator 352 may include a microporous or nanoporous polymer separator or a solid-state electrolyte, such as those described above in conjunction with the separator 26 of FIG. 1. When the separators 352 include the microporous or nanoporous polymer separators, the method may further include disposing a liquid or gel electrolyte on a first side 354 and a second side 356 of each separator 352. Additionally or alternatively, the liquid or gel electrolyte may be disposed on third sides 358 of each positive electrode 338 and fourth sides 360 of each negative electrode 340. The liquid or gel electrolyte may permeate through pores of the separator 352, and/or electrodes 338, 340. In certain aspects, the microporous or nanoporous polymer separator may be formed prior to step 218.

When the separators 352 include the solid-state electrolyte, additional liquid or gel electrolyte may be omitted. In certain aspects, the solid-state electrolytes are formed in situ. The solid-state electrolytes may be formed in situ by printing or deposition, such as plasma deposition. The solid-state electrolyte may be formed directly on the electrodes 332. In certain aspects, the method may including forming the solid-state electrolyte on the positive electrodes 338 and the negative electrodes 340. Accordingly, the separator 352 may include a first layer and a second layer in direct contact with one another, with the first layer being disposed adjacent to the positive electrode 338 and the second layer being disposed adjacent to the negative electrode 340.

### Electrically Connecting Positive and Negative Terminals

Returning to FIG. 4, at step 222, the method may further include coupling a positive terminal 364 and the negative terminal 366 to the third electrochemical device precursor 350. Coupling the positive and negative terminals 364, 366 to the third electrochemical device precursor 350 may include coupling the positive terminal 364 to one of the positive electrodes 338, and coupling the negative terminal 366 to one of the negative electrodes 340, as shown in FIG. 11A. Coupling the positive and negative terminals 364, 366 (step 222) may be performed at any point prior to forming the electrochemical device (step 234). For example, the terminals 364, 366 may be formed and coupled concurrently with the current collectors 244 at step 210. Accordingly, step 222 may be described as “coupling the positive and negative terminals 364, 366 to the first electrochemical device precursor 240” or “coupling the positive and negative terminals 364, 366 to two of the current collectors 244.” As will be discussed in greater detail below in conjunction with FIG. 16, locations and sizes of the terminals 364, 366 can be changed based on packaging requirements or desired current output. In certain aspects, step 222 may include connecting greater than two terminals to the third electrochemical device precursor 350.

### Forming a Fourth Electrochemical device Precursor

Returning to FIG. 4, the method may further include forming a fourth electrochemical device precursor. In certain aspects, with reference to FIG. 12, forming a fourth electrochemical device precursor 370 may include forming electrochemical cells 372. Forming the electrochemical cells may include folding the housing 242 along a boundary 374 (FIG. 11A) between the first film portion 246 and the second film portion 246. After folding, one of the first film portion 246 or the second film portion 246 lays substantially on top of the other of the first film portion 246 or the second film portion 246. The fourth electrochemical device precursor 370 may include a closed edge 382 along the boundary 374, and three open edges 384. After forming, each of the separators 352 is disposed between a pairs of electrodes 332 (i.e., one of the positive electrodes 338 and one of the negative electrodes 340) to form the electrochemical cells 372. Each of the electrochemical cells 372 is disposed between a pair of current collectors 244 (i.e., a positive electrode current collector 254 and a negative electrode current collector 256).

In various alternative aspects, forming may include stacking distinct first and second film portions. With reference to FIG. 13A, a first sheet of a second electrochemical device precursor 410 according to various aspects of the present disclosure is provided. The first sheet of the second electrochemical device precursor 410 may include a first film portion 412, a first portion 414-1 of a plurality of current collectors 414, and a third portion 416-1 of a plurality of electrodes 416. With reference to FIG. 13B, a second sheet of a second electrochemical device precursor 418 according to various aspects of the present disclosure is provided. The second sheet of the second electrochemical device precursor 418 may include a second film portion 420, a second portion 414-2 of the plurality of current collectors 414, and a fourth portion 416-2 of the plurality of electrodes 416.

With reference to FIG. 13C, a fourth electrochemical device precursor 422 according to various aspects of the present disclosure is provided. The fourth electrochemical device precursor 422 may be formed by stacking the first and second sheets of the second electrochemical device precursor 410, 418 with separators 424 disposed therebetween.

### Forming the Electrochemical device

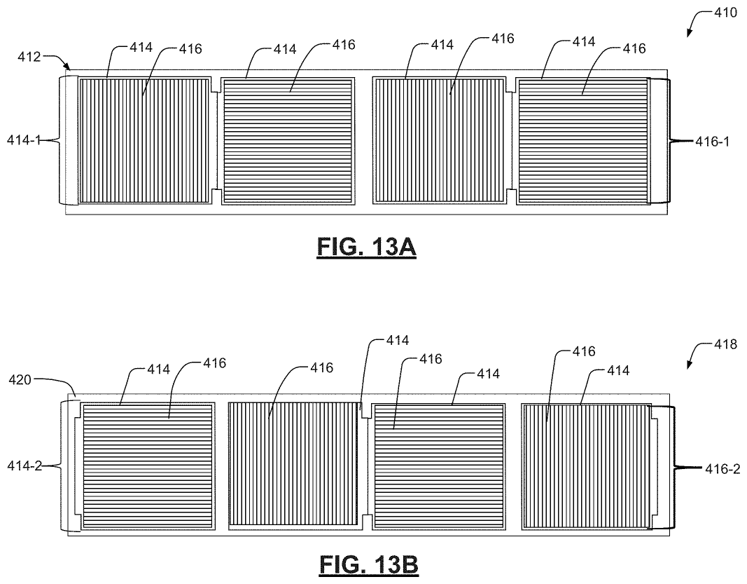

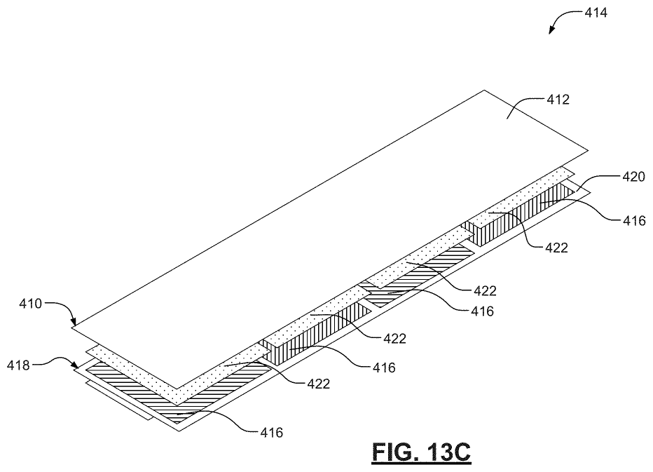

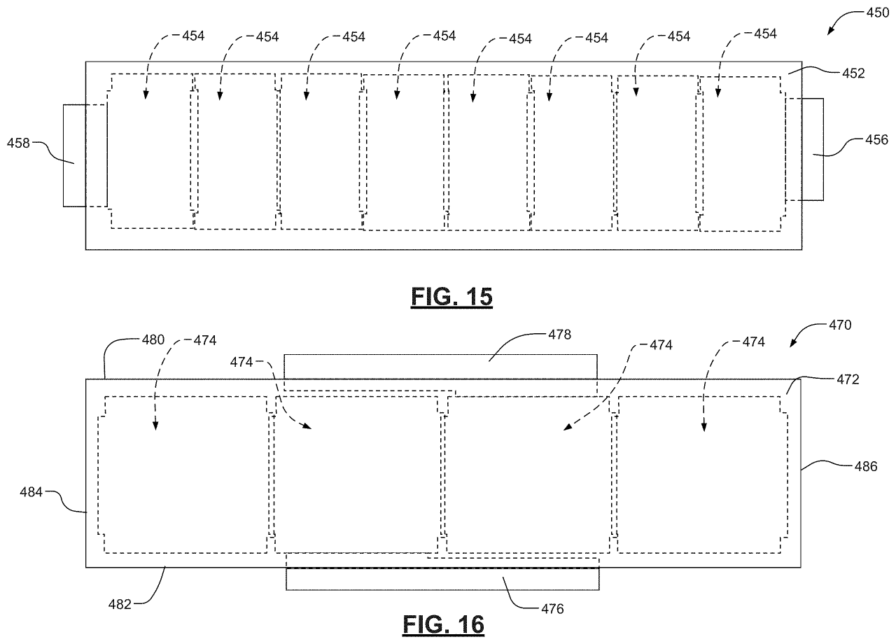

Returning to FIG. 4, at 234, the method may include forming an electrochemical device, such as a battery. As shown in FIG. 14, an electrochemical device 430 is formed by sealing the first film portion 246 to the second film portion 246. Sealing may including heat sealing. In certain aspects, a sealing region 431 may include a perimeter 432 and intermediate regions 434 between electrochemical cells 372. In various alternative aspects, a sealing region may include different or additional portions of the housing 242, such as substantially an entire surface of the housing 242. In certain aspects, sealing may include thermally contacting a heat sealing tool with the fourth electrochemical device precursor 370. Sealing may further include moving the heat sealing tool with respect to the fourth electrochemical device precursor 370 in a pattern corresponding with the sealing region 431. The heat sealing tool may be planar or have a three-dimensional shape to which the fourth electrochemical device precursor 370 conforms. The first and second film portions 246, 248 may be coupled to one another at the sealing region 431. Sealing may additionally or alternatively include applying an adhesive between the first and second film portions 246, 248. In one example, the separators 352 include solid state electrolytes, the electrochemical device 320 is free of liquid or gel electrolyte, and sealing includes applying an adhesive between the first and second film portions 246, 248.

### Forming the Electrochemical device Concurrently with Forming Electrical Connections

In various alternative aspects, forming the electrochemical device 430 (step 234) and forming electrical connections (step 212) may be performed concurrently, so that current collectors 244 are joined to one another during coupling of the first and second film portions 246, 248. In one example, sealing may include thermally contacting a heat sealing tool with the fourth electrochemical device precursor 370 around the perimeter 432 and the intermediate regions 434. A first temperature may be used for the perimeter 432 and a second temperature higher than the first temperature may be used for the intermediate regions 434. More particularly, the second temperature may be sufficiently high to create a solder joint between adjacent current collectors 244 (i.e., a portions of the current collectors 244 to be electrically connected) in the intermediate regions 434. In another example, an electrically-conductive adhesive is present between adjacent current collectors 244 (i.e., a portions of the current collectors 244 to be electrically connected). Sealing may include thermally contact a heat sealing tool with the fourth electrochemical device precursor 370 around the perimeter 432 and the intermediate regions 434. A first temperature may be used for the perimeter 432 and a second temperature different (e.g., higher) than the first temperature may be used for the intermediate regions 434. More particularly, the second temperature may be sufficient to cure the electrically-conductive adhesive in the intermediate regions 434.

### Adjusting a Voltage of a Battery

In various aspects, the method may further include adjusting a voltage of a battery. Adjusting a voltage of the battery may include adjusting a quantity of electrochemical cells in the battery. In certain aspects, sizes (i.e., lengths and widths) of electrochemical cells may be reduced, and a quantity of electrochemical cells increased within the same housing footprint (i.e., length and width) to increase voltage.

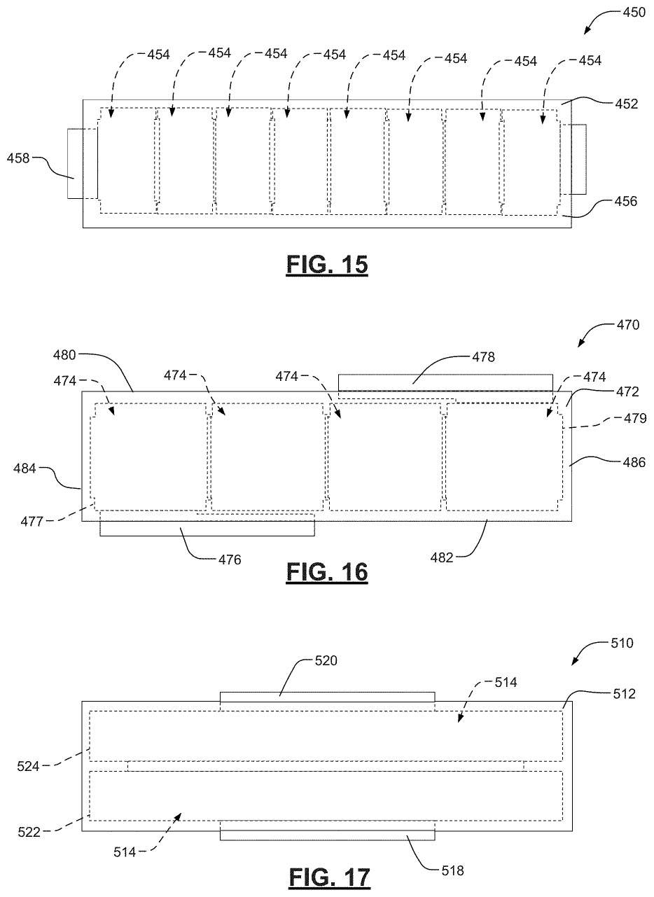

With reference to FIG. 15, a battery 450 according to various aspects of the present disclosure is provided. The battery 450 includes an electrically-insulating housing 452 having substantially the same length and width as the housing 62 of the battery 60 of FIG. 2. The battery 450 includes a plurality of electrochemical cells 454. The electrochemical cells 454 may be electrically connected to one another in series. The electrochemical cells 454 may be electrically connected to a negative terminal 456 and a positive terminal 458.

In certain aspects, the plurality of electrochemical cells 454 may include eight electrochemical cells 454. In one example, each of the electrochemical cells 454 has a voltage of about 4 volts. The battery 450 therefore has a voltage of about 32 volts. Accordingly, by halving a size of the electrochemical cells 454 and doubling a quantity of the electrochemical cells 454 compared to the electrochemical cells 110 of FIG. 2, a total voltage of the battery 450 is increased from 16 volts in the battery 60 to 32 volts in the battery 450 within substantially the same footprint.

### Adjusting a Current of a Battery

In various aspects, the method may further include adjusting a current of the battery 60. Adjusting a current of the battery 60 may include adjusting a cross-sectional area of the positive and negative terminals 364, 366 and/or the current collectors 244. With reference to FIG. 16, yet another battery 470 according to various aspects of the present disclosure is provided. The battery 470 includes an electrically-insulating housing 472, a plurality of electrochemical cells 474, a negative terminal 476, and a positive terminal 478. The electrochemical cells 474 are electrically connected to one another and to the negative and positive terminals 476, 478.

The housing 472 includes a first edge 480, a second edge 482 disposed opposite the first edge 480, a third edge 484, and a fourth edge 486 disposed opposite the third edge 484. The first and second edges 480, 482 extend substantially perpendicular to a length of the housing 472 and the third and fourth edges 484, 486 extend substantially parallel to a width of the housing 472. The first and second edges 480, 482 are longer than the third and fourth edge 484, 486.

The negative terminal 476 is electrically connected to a negative electrode current collector 477 and disposed on the first edge 480. The positive terminal 478 is electrically connected to a positive electrode current collector 179 and disposed on the second edge 482. The negative and positive terminals 476, 478 have larger cross-sectional areas (i.e., in a direction substantially perpendicular to a thickness of the battery 470) than the negative and positive electrode terminals 366, 364 of the battery 60 of FIG. 2. Therefore, compared to the battery 60, the battery 470 includes decreased current density in the terminals 476, 478 and increased total current.

It should also be appreciated that locations of terminals can be determined based on packaging requirements. Therefore, in certain aspects, positive and negative terminals may be disposed on opposing edges (e.g., first and second edges 480, 482 or third and fourth edges 484, 486). In certain alternative aspects, the positive and negative terminals may be disposed on perpendicular edges (e.g., first and third edges 480, 484, first and fourth edges 480, 486, second and third edges 482, 484, or second and fourth edges 482, 486). In certain aspects, the positive terminal and/or the negative terminal may extend across more than one edge.

Referring to FIG. 17, another battery 510 according to various aspects of the present disclosure is provided. The battery 510 includes an electrically-insulating housing 512 and a plurality of electrochemical cells 514. The plurality of electrochemical cells 514 may include two electrochemical cells 514. The battery 510 further includes a negative terminal 518 and a positive terminal 520. The negative terminal 518 is electrically connected to a negative electrode current collector 522. The positive terminal 520 is electrically connected to a positive electrode current collector 524. The current collectors 522, 524 have increased cross-sectional areas compared to the current collectors 477, 479 of the battery 470 of FIG. 16.

### Electrically Connecting Multiple Electrochemical devices

In various aspects, the method may further include electrically connecting multiple electrochemical devices 60 to increase a total voltage or total current of an electrochemical device system. The electrochemical devices 60 may be connected in series and/or in parallel. The electrochemical devices 60 may be electrically connected via secondary electrical connections at positive and negative terminals 364, 366. Secondary electrical connections may be formed by welding, for example.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A thin, conformable electrochemical device comprising:
an electrically-insulating housing comprising a first film portion and a second film portion cooperating to at least partially define an interior region;
a plurality of current collectors disposed within the interior region, the plurality of current collectors including a first current collector coupled to the first film portion, a second current collector coupled to the first film portion, a third current collector coupled to the second film portion, and a fourth current collector coupled to the second film portion;
a plurality of electrochemical cells disposed within the interior region and electrically connected to one another, the plurality of electrochemical cells comprising,
a first electrochemical cell comprising, a first positive electrode electrically connected to one of the first current collector or the third current collector, a first negative electrode electrically connected to the other of the first current collector or the third current collector, and a separator disposed between the first positive electrode and the first negative electrode, and
a second electrochemical cell comprising, a second positive electrode electrically connected to one of the second current collector or the fourth current collector, a second negative electrode electrically connected to the other of the second current collector or the fourth current collector, and a separator disposed between the second positive electrode and the second negative electrode,
a positive terminal electrically connected to the plurality of electrochemical cells and extending from the interior region to an exterior region of the electrically-insulating housing; and
a negative terminal electrically connected to the plurality of electrochemical cells and extending from the interior region to the exterior region of the electrically-insulating housing.

2. The thin, conformable electrochemical device of claim 1, wherein the first electrochemical cell and the second electrochemical cell are electrically connected in series.

3. The thin, conformable electrochemical device of claim 1, wherein the plurality of electrochemical cells includes at least one series electrical connection and at least one parallel electrical connection.

4. The thin, conformable electrochemical device of claim 1, wherein the first current collector is in direct contact with the second current collector.

5. The thin, conformable electrochemical device of claim 4, wherein:
a first layer comprising a first electrically-conductive material is disposed on the first film portion in a first region and a second region;
a second layer comprising a second electrically-conductive material is disposed on the first layer in the first region; and
the first current collector comprises the first layer and the second layer in the first region and the second current collector comprises the first layer in the second region.

6. The thin, conformable electrochemical device of claim 1, wherein the thin, conformable electrochemical device is configured to be bent about a first axis and a second axis substantially perpendicular to the first axis.

7. The thin, conformable electrochemical device of claim 1, wherein the thin, conformable electrochemical device has a thickness of less than or equal to about 0.5 mm.

8. The thin, conformable electrochemical device of claim 1, wherein the plurality of electrochemical cells comprises greater than or equal to ten electrochemical cells.

9. A method of manufacturing a thin, conformable electrochemical device, the method comprising:
forming a first precursor by coupling a plurality of current collectors to an electrically-insulating housing, a first portion of the plurality of current collectors being coupled to a first film portion of the housing and a second portion of the plurality of current collectors being coupled to a second film portion of the housing;
forming a second precursor by disposing a plurality of electrodes on the plurality of current collectors, a third portion of the plurality of electrodes being disposed on the first portion of the plurality of current collectors, respectively, and a fourth portion of the plurality of electrodes being disposed on the second portion of the plurality of current collectors, respectively;
forming a third precursor by disposing a plurality of separators on a fifth portion of the plurality of electrodes;
forming a fourth precursor by assembling a plurality of electrochemical cells, each electrochemical cell including a separator of the plurality of separators disposed between an electrode of the third portion of the plurality of electrodes and an electrode of the fourth portion of the plurality of electrodes;
electrically connecting the plurality of electrochemical cells to one another; and
forming the electrochemical device by coupling the first film portion to the second film portion, the first film portion and the second film portion cooperating to at least partially define an interior region in which the plurality of electrochemical cells are disposed, the positive terminal and the negative terminal each extending from the interior region to an exterior region.

10. The method of claim 9, wherein the forming the first precursor comprises at least one of printing or plasma-depositing the plurality of current collectors on the electrically-insulating housing.

11. The method of claim 10, wherein:
the forming the first precursor is performed concurrently with the electrically connecting; and
the electrically connecting comprises directly contacting a first current collector of the first portion of the plurality of current collectors with a second current collector of the first portion of the plurality of current collectors.

12. The method of claim 10, wherein:
the forming the first precursor comprises at least one of printing or plasma-depositing a first layer on a first region of the first film portion and a second region of the first film portion, and a second layer on the first layer in the first region, the first layer comprising a first electrically-conductive material and the second layer comprising a second electrically-conductive material; and
a first current collector comprises the first layer and the second layer and is disposed in the first region and a second current collector comprises the first layer and is disposed in the second region.

13. The method of claim 9, wherein the forming the second precursor comprises at least one of printing or plasma-depositing the plurality of electrodes on the plurality of current collectors, respectively.

14. The method of claim 9, wherein the electrically connecting comprises forming a joint between a pair of electrochemical cells of the plurality of electrochemical cells, the forming comprising at least one of printing, plasma-depositing, welding, laser joining, resistance joining, or soldering.

15. The method of claim 9, wherein the forming the third precursor comprises at least one of printing or plasma-depositing a solid-state electrolyte on the fifth portion of the electrodes.

16. The method of claim 15, wherein the fifth portion of the electrodes includes every electrode of the plurality of electrodes.

17. The method of claim 9, wherein:
the electrically-insulating housing comprises a sheet comprising the first film portion and the second film portion; and
the forming the fourth precursor comprises folding the sheet along a boundary between the first film portion and the second film portion such that the plurality of separators is disposed between the third portion of the plurality of electrodes and the fourth portion of the plurality of electrodes.

18. The method of claim 9, wherein the forming the fourth precursor comprises stacking one of the first film portion or the second film portion on the other of the first film portion or the second film portion such that the plurality of separators is disposed between the third portion of the plurality of electrodes and the fourth portion of the plurality of electrodes.

19. The method of claim 9, further comprising adjusting a voltage of the electrochemical device by adjusting a quantity of electrochemical cells of the plurality of electrochemical cells, the plurality of electrochemical cells being electrically connected in series.

20. The method of claim 9, further comprising adjusting a current of the electrochemical device by adjusting at least one of (i) a first cross sectional area of the positive terminal, (ii) a second cross sectional area of the negative terminal, or (iii) third cross sectional areas of the plurality of current collectors.
